(19) United States
(12) Patent Application Publication
(10) Pub. No.: US 2005/0161560 A1
(43) Pub. Date: Jul. 28, 2005

(54) Holder for cameras

(76) Inventor: Mikael Kjellman, Froson (SE)

Correspondence Address: YOUNG & THOMPSON, 745 SOUTH 23RD STREET, 2ND FLOOR, ARLINGTON, VA, 22202, US

(21) Appl. No.: 10/762,382

(22) Filed: Jan. 23, 2004

(51) Int. Cl. F16M 11/00

(52) U.S. Cl. 248/163.1

(57) ABSTRACT

A holder for cameras, comprising three arms that are interconnected at inner ends thereof through a common, central joint device, and a camera fixture. The camera fixture is located on an outer end of a first arm or main arm, the second and third arms forming side arms that are individually pivotable and lockable in different angular positions in relation to the main arm.

### TECHNICAL FIELD OF THE INVENTION

This invention relates to a holder intended for cameras and comprising three arms that are interconnected at inner ends thereof through a common, central joint device, and a camera fixture.

### STATE OF THE ART

Camera holders of the type mentioned above are traditionally formed by stands of the type that has its task to support and fix a camera at a requested level above a supporting surface, for example the ground. Normally, such stands comprises three telescopically extendable arms or legs that are pivotally connected to a common upper camera fixture. More precisely, the upper end of each arm is connected to the camera fixture, while the bottom ends are free in order to be applied to the surface while forming a tripod for the camera.

The application possibilities for such traditional camera stands are, generally, the support and fixation of the camera at a given level above the supporting surface. However, during photographing and filming with a camera, there will be a plurality of different situations in which there is a need of a versatile camera holder. Examples of such situations will be shown in the following description and on the drawings.

### OBJECT OF THE INVENTION

It is the object of the present invention to overcome the above drawback and to present a multifunctional camera holder that makes it possible to facilitate or permit photographing/filming while standing I certain positions and under circumstances for which it has previously been difficult or even impossible to use a camera with a satisfactory result. Accordingly, one object of the invention is to present a camera holder that permits photographing/filming at a high above head level, for example above a crowd, a fence, a hedge or the like. It is a further object to present a camera holder that permits photographing/filming at a low level for example in the vicinity of the ground. It is a further object of the invention to present a camera holder that is easily used for stabilizing a camera while the latter is held by hand. It is a further object of the invention to present a camera holder which, upon need, can be used as a supporting stand when the user wishes to fix the camera in a given position without gripping the holder manually. It is also an object of the invention to present a camera holder that a user will find comfortable to bring with him. It is a further object of the invention to present a camera holder that permits setting/holding of the camera in varying angles.

### SUMMARY OF THE INVENTION

The objects of the invention are achieved by means of a camera holder as initially defined, characterized in that the camera fixture is arranged on an outer end of a first arm, or main arm, said second and third arms forming side arms that are individually pivotable and lockable in different angular positions in relation to the main arm.

According to a further embodiment, the individual side arms are both axially and radially pivotable in relation to the main arm.

Preferably, the two side arms are of equal length and weight.

According to a further embodiment, adjustable weight elements are connected to the outer ends of the side arms.

According to a further embodiment the main arm comprises two or more telescope tubes that are lockable in different axial positions in relation to each other for the purpose of permitting a variation of the length of the main arm.

Preferably, each side arm comprises two or more telescope tubes that are lockable in different axial positions in relation to each other, for the purpose of permitting a variation of the length of each side arm.

According to a further embodiment the camera holder comprises a plate that is connected to outer end of the main arm to a lockable joint that permits the plate to be pivoted around the first axis perpendicular to the longitudinal axis of the main arm, and permits the plate and a camera that is directly or indirectly supported thereby to be locked in different angular positions in relation to the main arm.

Preferably, the camera holder also comprises a second plate 31, which is connected with the first plate through a second lockable joint that permits the second plate to be pivoted around a second axis perpendicular to said first axis, the second plate being lockable in different angular positions in relation to the first plate and being equipped with means for fixation of a camera.

### FURTHER PRIOR ART

A camera holder with two arms and a camera fixture located at a free end of one of the arms is disclosed in U.S. Pat. No. 5,243,370. However, this camera holder does not present a pair of interacting side arms that are individually pivotable and lockable in different angular positions in relation to the main arm that carries the camera fixture.

Further camera holders are disclosed in U.S. Pat. No. 5,098,182, DE 2248379 and SE 9600430-4. Nor do any of these camera holders comprise any interacting pair of side arms that are individually pivotable and lockable in different angular positions in relation to a main arm provided with a camera fixture at its free end.

Tripod camera holders provided with fixtures for cameras are also disclosed in U.S. Pat. No. 4,439,032, U.S. Pat. No. 5,513,784 and U.S. Pat. No. 6,254,044. As by other conventional camera holders, the arms are pivotally connected as their inner ends with a common camera fixture. In other words, in these cases, the camera fixture are not located at a free, outer end of any kind of main arm, which is the characterizing feature of the present invention.

### BRIEF DESCRIPTION OF THE DRAWINGS

On the drawings:

FIG. 1 is a perspective view of a camera holder according to the invention, the arms of the holder being set to form supporting stand,

FIG. 2 is a side view of the camera holder in a folded condition in which it is stored or transported,

FIG. 3 is an exploded view showing the components of the camera holder,

FIG. 4 is a perspective, detailed view showing a lockable joint that forms a part of the holder,

FIG. 5 is a perspective view showing one application alternative, by which the holder is at least partially carried on a user shoulder,

FIG. 6 is an enlarged view from above of the holder in the same condition as in FIG. 5,

FIG. 7 is a perspective view showing another application alternative, by which the user holds the camera high,

FIG. 8 is a side views showing the camera holder in the position according to FIG. 7,

FIG. 9 is a perspective view showing a further alternative application, by which the user, with his arm straight up, holds the camera holder in a balanced position,

FIG. 10 is a side view of the camera holder in the position according to FIG. 9,

FIG. 11 is a perspective view showing the camera holder in connection with a photographing/filming operation with the camera in a low balanced position,

FIG. 12 is a side view of the camera holder in the position according to FIG. 11,

FIG. 13 is a side view showing the camera holder as set for photographing/filming in an extremely low but still balanced position, and

FIG. 14 is a side view illustrated a further alternative application.

### DETAILED DESCRIPTION OF A PREFERRED EMBODIMENT OF THE INVENTION

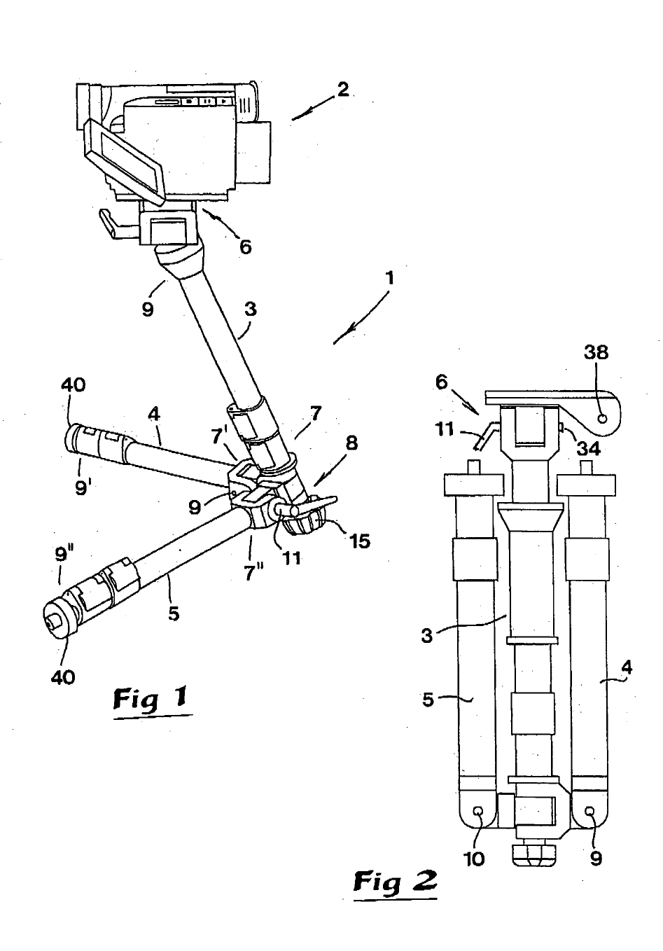

In FIG. 1 reference numeral 1 indicates an inventive holder for a camera 2. The holder comprises three arms 3, 4, 5 and a camera fixture generally denoted 6. The three arms are interconnected at their respective inner ends through a central joint or joint device generally denoted 8. One arm 3, forms a main arm which, at its outer end 9, is connected with the camera fixture 6. The two other arms 4, 5 form side arms that are individually pivotable in relation to the main arm through individual joints that are generally denoted with 9, 10 (see also FIG. 2). Each of these joints is of a lockable type, comprising a locking mechanism 11 of a type that is exemplified in FIG. 4. In FIG. 1, the other, free ends of the side arms 4, 5 are denoted 9′ and 9″ respectively.

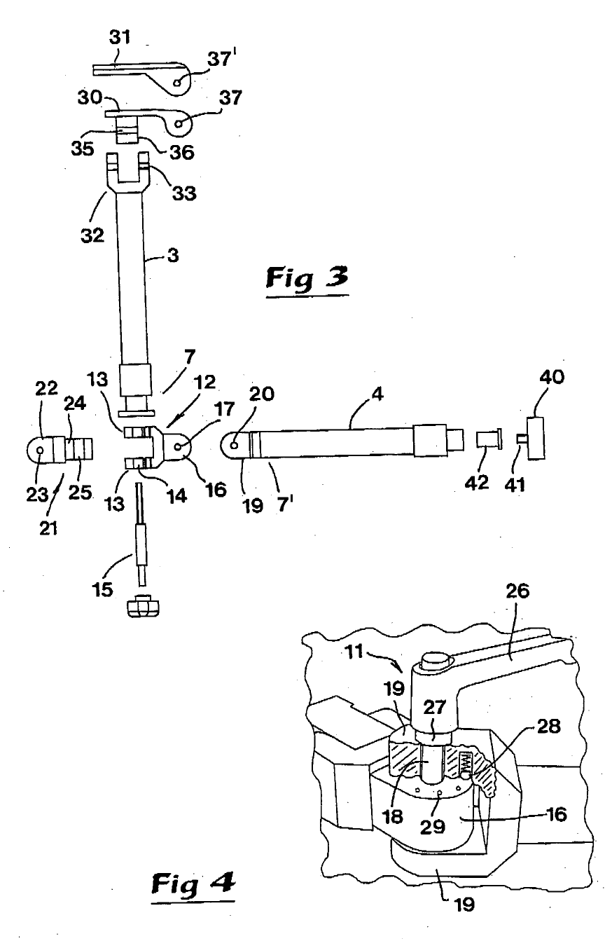

FIG. 3 shows, in an exploded view, the different components that are included in the holder. A uniting component in the central joint device 8 is formed by a first fork element 12 provided with separated legs 13 in which there are provided holes 14 for a screw 15 that can be screwed into a female threading (not shown) provided in the inner end of the main arm 3. In a direction opposite to the legs 13, there is provided an ear 16 with a hole 17 for a pivot pin 18 of the type that is shown in FIG. 4.

At its inner end 7′ the side arm 4 is provided with a fork 19, the legs of which comprises a hole 20 for the pivot pin 18 (that forms the joint 9).

For the arm 5 not shown in FIG. 3 there is arranged a second fork element 21, which, likewise to said first fork element 12, comprises two legs 22 with holes 23 for a pivot pin 18 (that forms the joint 10). The fork element 21 also includes an ear 24 provided with a central hole 25 through which the screw 15 can be guided.

The two fork elements 12, 21 are individually pivotable around the central axis formed by the screw 15 and extending as an extension of the main arm 3. Accordingly, the ear on the fork element 21 of the arm 5 can be pivoted between arbitrary angular positions in relation to the screw 15. In the same way, the two legs 13 of the fork element 12 can be pivoted around the screw 15 as long as the latter is not tightened. By the tightening of the screw, the two fork elements are locked in the requested angular positions.

The lock mechanism 11 shown in FIG. 4 comprises, apart from the pivot pin 18, a handle 26 which is attached on to a sleeve 27 provided with an inner threading (not shown). This threading is engaged with an outer threading on the pivot pin 18. The opposite end of the pin is locked in a leg. When handle 26 is tightened, the ear 16 is clamped between the two legs.

As is indicated in FIG. 4, a spring loaded ball 28 may interact with a number of separate seats 29 in the ear 16. These seats define predetermined angle position settings.

Accordingly, each individual side arm 4, 5 can be pivoted and set in two different planes or directions in relation to the main arm. Accordingly, each individual side arm can be pivoted either axially in relation to the main arm, or more precisely around the joints 9, 10, or radially in relation to the main arm, by being pivoted around the geometric centre axis defined by the screw 15. In all these position settings, the side arms may be locked by means of the lock mechanisms 11 and the screw 15 respectively.

The camera fixture 6 comprises two plates 30, 31, the first of which is jointly connected with the outer end of the main arm 3. More precisely, the main arm 3 is designed as a fork 32 with two legs in which there are holes 33 for a pivot pin 34 (see FIG. 2). The pivot pin can be inserted into a through hole 35 in a heel 36 on the lower side of the plate 30. At one of its ends the plate 30 presents flanges with holes 37 for a pivot pin 38 (see FIG. 2), which is guided through analogous holes 37′ provided in exterior flanges provided on the second plate 31. In the second plate 31 there is at least one hole (not shown) for the attachment of the camera 2 by means of a screw (not shown).

When the camera 2 is positioned on the second plate 31, it can be turned or pivoted in two different directions in relation to the main arm 3. Accordingly, the first plate 30 can be turned or pivoted around the joint 34, while the second plate 31 can be pivoted towards or away from the plate 30 through the joint 38.

According to a preferred embodiment of the invention, the main arm 3 is telescopically extensible as it comprises two or more telescope tubes 3′, 3″, 3′″ (see FIG. 8), which are lockable in different axial positions in relation to each other by means of conventional locking sleeves 39.

Also each of the two side arms 4, 5 may comprise two or more telescope tubes 4′, 4″, 4′″ and 5′, 5″, 5′″ respectively, said tubes being lockable in different extension positions by means of locking sleeves 39.

According to the invention, the two side arms may be of equal length and weight, while the design of the main arm may be different from that of the side arms. Hereby, the two side arms may, if needed, serve as balancing bodies. As can be seen in FIG. 1-3, dedicated weights 40 may be arranged on the free, outer ends 9′, 9″ of the side arms 4, 5. By means of a screw 41 and a plug 42, the weights 40 can be screwed into and out of the associated side arm for the purpose of finely adjusting the torque of the side arm around the joint device 8. In that way, the balance of the holder can be finely adjusted.

### THE USE OF THE CAMERA HOLDER ACCORDING TO THE INVENTION

In FIG. 1, the arms 3, 4, 5 of the holder are shown as set and locked in predetermined positions in which the holder can be used as a stationary stand for the camera 2. In this position the side arms may be perpendicular to each other in a common horizontal plane, while the main arm 3 projects upwards with a requested angle in relation to said plane.

FIG. 2 shows the holder in a folded condition in which it can be stored or transported. In this case, the two side arms 4, 5 are folded towards the main arm 3, and all the telescope tubes are fully inserted in to each other. In that way, all arms obtain the same minimal length.

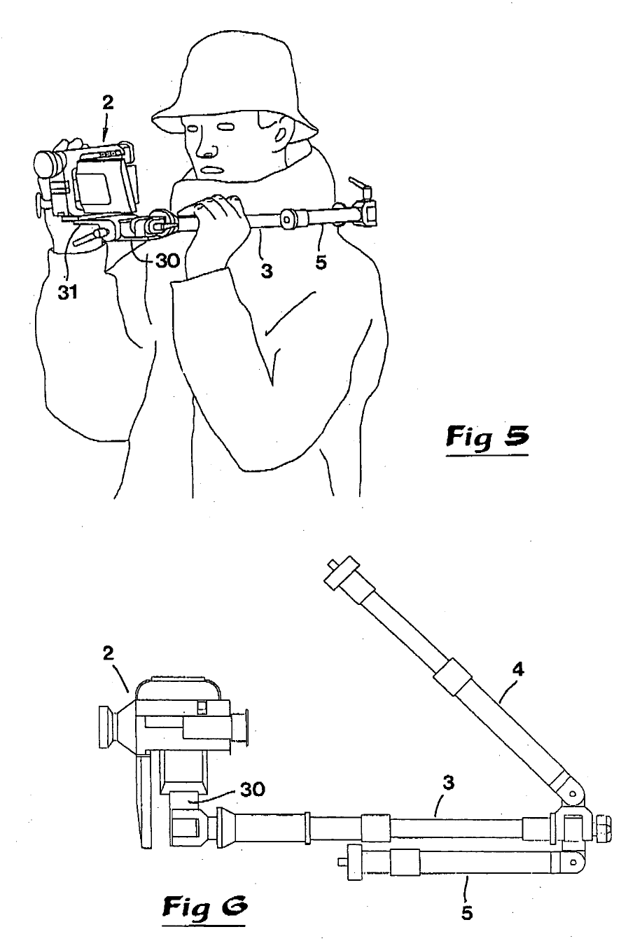

FIGS. 5 and 6 show the camera holder in a condition for photographing/filming at an eye level. In this case, the first side arm 5 is still folded towards the main arm 3 and of the minimum length. Second side arm 4 is pivoted to an angle of approximately 45° in relation to the main arm and extended by means of the extension of at least one of the telescope tubes. Also the main arm 3 is somewhat extended in relation to the storing condition according to FIG. 2. Further, the plate 31 is turned over to an angle of 180° in relation to the plate 30. With the camera holder in this condition, the user can hold the main arm 3 with his left hand, while he can manoeuvre the camera with his right hand. The pivoted first side arm 4 rests on the right shoulder of the user. Accordingly, the camera can be held in a stable position while the user still has one hand free for the manoeuvring of the camera.

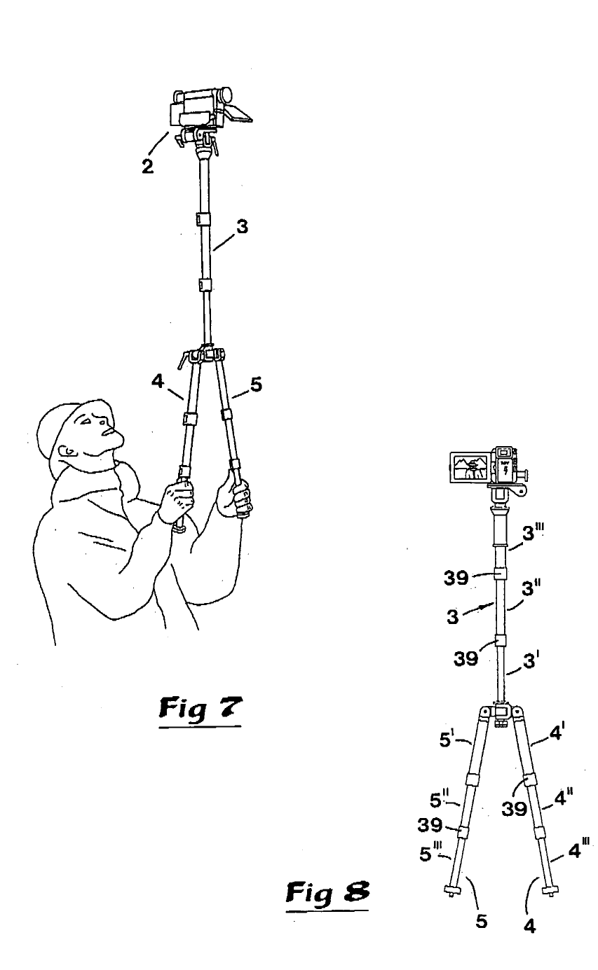

FIGS. 7 and 8 show the holder in a position for filming/photographing at a high level. In this case all the telescope tubes of the three arms are extended to a maximum. Furthermore, the two side arms 4, 5 are set in a somewhat acute angle in relation to each other, and the side arms extend in a direction opposite to the one of the main arm 3. In this case, the user can go on filming or photographing without being obstructed by, for example, a crowd, a fence, a hedge or the like. With the holder in the condition shown in FIGS. 7 and 8, the latter may also rest with the free ends of the side arms supported by the ground.

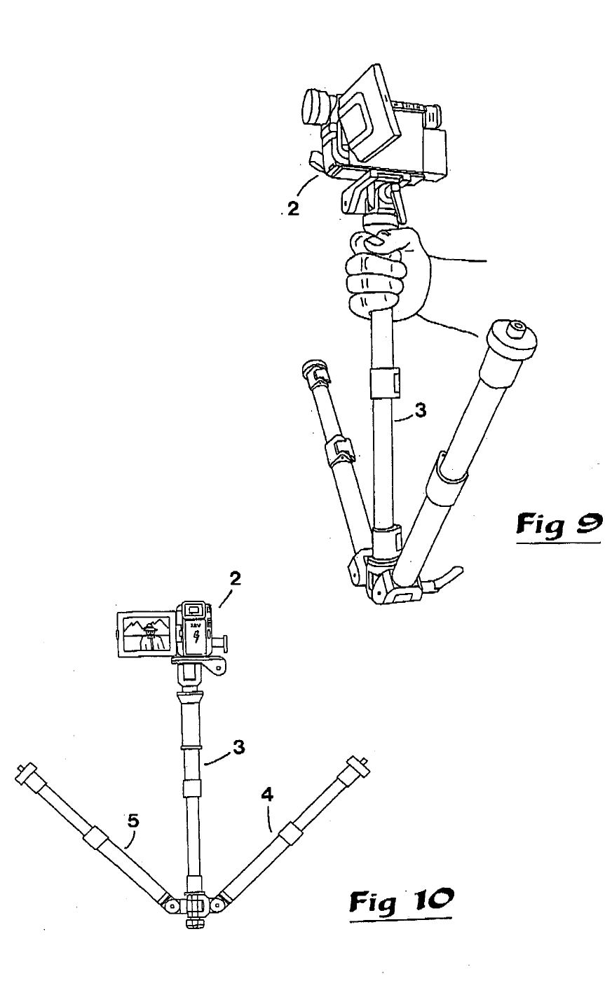

FIGS. 9 and 10 show the holder in a condition in which the two side arms are swung out in equal and acute angles in relation to the main arm 3. Hereby, the two side arms serve as a balancing weight which guarantees that the main arm is in a vertical position when grabbed by the hand of the user, as shown in FIG. 9. With the holder in this condition, the common centre of gravity of the holder of the camera is positioned in the centre of the main arm, which serves as the handle. Thus, a stable retention of the camera during, for example, filming, is guaranteed.

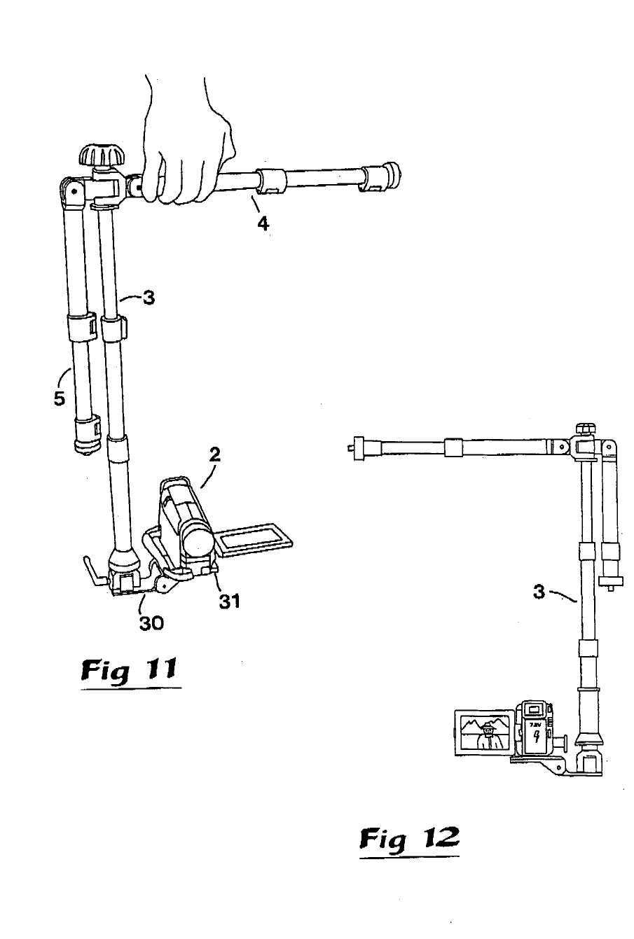

FIGS. 11 and 12 show the holder as set for filming/photographing in a low position, for example, close to the ground. In this case, the first side arm 4 is pivoted to a perpendicular position in relation to the main arm 3, while the other side arm 5 is folded towards the main arm and parallel with the latter. The attachment plate 31 is pivoted such that it has an angle of 180° in relation to the first plate 30, and the camera is located at the same side of the main arm 3 as the first side arm 4. Also with the holder in this condition, the user can use one hand to hold the camera holder while the main arm is in a vertical position. The possibility of filming/photographing at a low level while standing is advantageous for example when there are obstacles in front of the user that do not reach the ground. It is also an advantage that the user does not need to crouch down while photographing or filming objects at a low level, for example, crawling children, pets, flower beds, etc.

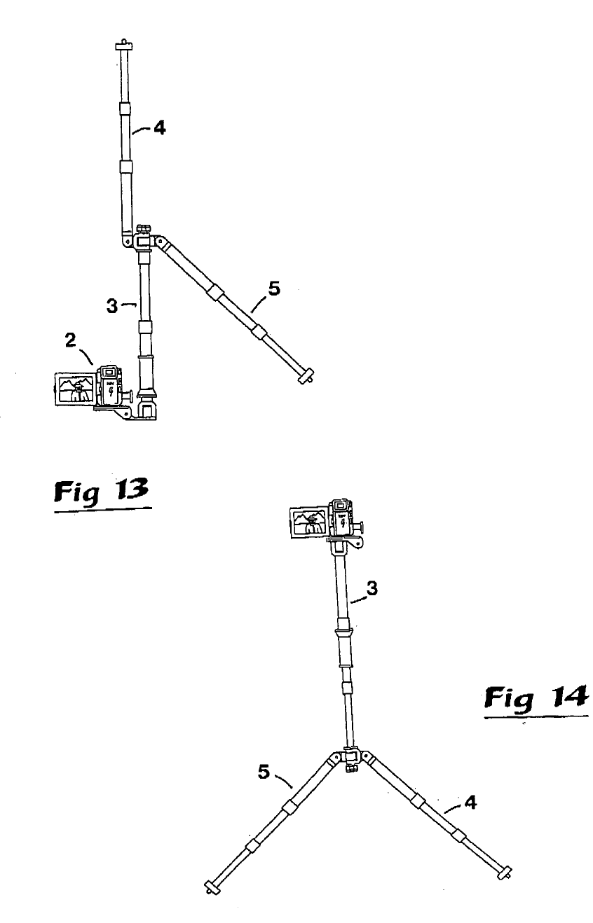

FIG. 13 shows how the camera holder can make filming/photographing possible at a level even lower than the one of FIGS. 11 and 12. In this case, the side arm 4 is pivoted 180° in relation to the main arm 3, while the second side arm 5 is pivoted into an acute angle in relation to main arm in order to serve as a counterweight to the camera. In this case, the user may grip the holder in the area of the outer end of the first side arm 4.

FIG. 14 shows the holder in a condition in which the two side arms 4, 5 are pivoted to an obtuse angle in relation to main arm 3. In this case, the user may use one hand to hold the main arm 3, while the holder, in the same way as in FIGS. 9 and 10, is stabilized in a hanging position in which the centres of gravity of the camera and the holder respectively are located along the central line of the main arm 3. As the telescope tubes of the side arms 4, 5 are extended, the holder presents a considerable inertia.

It is an advantage of the camera holder according to the invention that it can be set for very different use situations, and the holder facilitates filming and photographing or even makes such operations possible where otherwise not possible. It should be noted that the arms can be set and locked in relation to each other in many other ways than those exemplified on the drawings. The camera can also be set and locked in relation to the main arm in many other ways than those that have been described by way of example.

1. A holder for cameras, comprising three arms that are interconnected at inner ends thereof through a common, central joint device, and a camera fixture, wherein the camera fixture is located on an outer end of a first arm or main arm, the second and third arms forming side arms that are individually pivotable and lockable in different angular positions in relation to the main arm.

2. A holder according to claim 1, wherein the individual side arm is both axially and radially pivotable in relation the main arm.

3. A holder according to claim 1, wherein the two side arms are of the same length and weight.

4. A holder according to claim 1, wherein adjustable weight elements are connected to the outer ends of the side arms.

5. A holder according to claim 1, wherein the main arm comprises two or more telescope tubes that can be locked in different axial positions in relation to each other for the purpose of permitting a variation of the length of the main arm.

6. A holder according to claim 1, wherein the individual side arm includes two or more telescope cubes that are lockable in different axial positions in relation to each other for the purpose of permitting a variation of the length of the individual side arms.

7. A holder according to claim 1, wherein the camera fixture comprises a plate which is connected to the outer end of the main arm through a lockable joint that permits pivotation of the plate around a first axis perpendicular to the longitudinal axis of the main arm, and permits a fixation of the plate together with a camera directly or indirectly supported thereby in two different angular positions in relation to the main arm.

8. A holder according to claim 7, wherein the camera fixture, in addition to said first plate, comprises a second plate which is connected to the first plate through a second lockable joint, that permits a pivotation of the second plate around a second axis perpendicular to said first axis, the second plate being lockable in different angular positions in relation to the first plate and being equipped with means for attachment of a camera.
